(19) United States
(12) Patent Application Publication
(10) Pub. No.: US 2020/0096818 A1
(43) Pub. Date: Mar. 26, 2020

(54) BACKLIGHT CIRCUIT, BACKLIGHT MODULE, AND DISPLAY DEVICE

(71) Applicants: FUZHOU BOE OPTOELECTRONICS TECHNOLOGY CO., LTD., Fuzhou (CN); BOE TECHNOLOGY GROUP CO., LTD., Beijing (CN)

(72) Inventor: Xin CHEN, Beijing (CN)

(21) Appl. No.: 16/408,915

(22) Filed: May 10, 2019

(30) Foreign Application Priority Data
Sep. 26, 2018 (CN) 201811123652.9

(51) Int. Cl. G02F 1/1335; G09G 3/34; G09G 3/36

(52) U.S. Cl. CPC G02F 1/133602; G09G 3/3688; G09G 3/3406

(57) ABSTRACT

A backlight circuit, a backlight module, and a display device are provided. The backlight circuit includes: a first output end configured to connect to a positive power supply end of at least one string of light emitting elements; at least one second output end configured to connect to a negative power supply end of the at least one string of light emitting elements respectively; a power supply circuit configured to provide a positive power supply voltage to the first output end and to provide a constant voltage to the first node based on a first buck conversion performed on a power supply voltage; and a current control circuit configured to provide a negative power supply voltage, which is obtained by performing a second buck conversion on the constant voltage, to the second node to control a current between each second output end and the second node.

### CROSS REFERENCE TO RELATED APPLICATIONS

The present application claims priority of Chinese Patent Application No. 201811123652.9, filed on Sep. 26, 2018, the disclosure of which is incorporated herein by reference in its entirety as part of the present application.

### TECHNICAL FIELDS

The embodiments of the present disclosure relate to a backlight circuit, a backlight module, and a display device.

### BACKGROUND

A backlight is an important component of a liquid crystal display (LCD), and generally comprises a plurality of strings formed by light emitting elements connected in series and a circuit structure for controlling these strings to emit light. A voltage across a string formed by light emitting elements connected in series is distributed to each of the light emitting elements in the string. Thus, the voltage across the string is generally high (for example, the voltage difference across the string exceeds 100V). At present, a method to provide this high voltage is usually to perform a boost conversion on an operating voltage (generally about 12V) of the circuit structure. In this way, high voltage resistant devices are required in the circuit structure, and additional protection circuits may be required to prevent high voltage damage, which is disadvantageous for simplifying the circuit structure in the backlight.

### SUMMARY

Some embodiments of the present disclosure provide a backlight circuit, and the backlight circuit comprises: a first output end configured to connect to a positive power supply end of at least one string of light emitting elements; at least one second output end configured to connect to a negative power supply end of the at least one string of light emitting elements respectively; a power supply circuit connected to the first output end and a first node respectively, and configured, based on a first buck conversion performed on a power supply voltage, to provide a positive power supply voltage for the at least one string of light emitting elements to the first output end and to provide a constant voltage to the first node; and a current control circuit connected to the first node, a second node, and each of the at least one second output end respectively and configured to provide a negative power supply voltage, which is obtained by performing a second buck conversion on the constant voltage, to the second node to control a current between each of the at least one of second output end and the second node.

For example, in the backlight circuit according to the some embodiments of the present disclosure, the current control circuit comprises a current mirror sub-circuit, the current mirror sub-circuit is connected to the second node and each of the at least one second output end respectively, and the current mirror sub-circuit is configured to lock the current between the second node and each of the at least one of second output end to a same current value and collect the same current value.

For example, in the backlight circuit according to the some embodiments of the present disclosure, the current control circuit further comprises a current regulation sub-circuit, the current regulation sub-circuit is connected to the current mirror sub-circuit, the first node, and the second node respectively, and the current regulation sub-circuit is configured to perform the second buck conversion on the constant voltage according to the same current value collected by the current mirror sub-circuit, and to provide the negative power supply voltage obtained through the second buck conversion to the second node.

For example, in the backlight circuit according to the some embodiments of the present disclosure, the current mirror sub-circuit comprises a first transistor, a second transistor, a first resistor, a second resistor, at least one third transistor, and at least one third resistor, and the current regulation sub-circuit comprises an operational amplifier; a first electrode of each of the at least one third transistor is connected to a corresponding second output end of the at least one second output end, a second electrode of each of the at least one third transistor is connected to a first end of a corresponding third resistor of the at least one third resistor, and a gate electrode of each of the at least one third transistor is connected to a gate electrode of the second transistor, a second end of each of the at least one third resistor is connected to the second node, a gate electrode of the first transistor is connected to an output end of the operational amplifier, a first electrode of the first transistor is connected to a first power supply end of the current control circuit, a second electrode of the first transistor is connected to a first end of the first resistor, and a second end of the first resistor is connected to a gate electrode of the second transistor, and a first electrode of the second transistor is connected to the second end of the first resistor, a second electrode of the second transistor is connected to an inverting input end of the operational amplifier and a first end of the second resistor, a second end of the second resistor is connected to the second node, and a non-inverting input end of the operational amplifier is configured to receive a reference voltage.

For example, in the backlight circuit according to the some embodiments of the present disclosure, a type of the second transistor is same as a type of the at least one third transistor.

For example, in the backlight circuit according to the some embodiments of the present disclosure, the first power supply end is electrically connected to the first node.

For example, in the backlight circuit according to the some embodiments of the present disclosure, a number of the at least one third transistor is same as a number of the at least one third resistor, and the at least one third transistor and the at least one third resistor are connected in one-to-one correspondence.

For example, in the backlight circuit according to the some embodiments of the present disclosure, a number of the at least one second output end is same as a number of the at least one third transistor, and the at least one second output end and the at least one third transistor are connected in one-to-one correspondence.

For example, in the backlight circuit according to the some embodiments of the present disclosure, the current regulation sub-circuit further comprises a fourth transistor, an inductor, a first diode, a first capacitor, and a pulse width modulation circuit; a gate electrode of the fourth transistor is connected to a pulse signal output end of the pulse width modulation circuit, a first electrode of the fourth transistor is connected to the first node, and a second electrode of the fourth transistor is connected to a first end of the inductor and a negative electrode of the first diode, a second end of the inductor is connected to a common end, a positive electrode of the first diode is connected to the second node and a first end of the first capacitor, a second end of the first capacitor is connected to the common end, and an input end of the pulse width modulation circuit is connected to an output end of the operational amplifier, the pulse width modulation circuit is further connected to the first power supply end and a second power supply end of the current control circuit respectively, and the pulse width modulation circuit is configured to modulate a duty ratio of a pulse signal at the pulse signal output end according to a signal received at the input end of the pulse width modulation circuit, to keep a current between the first output end and the second node constant.

For example, in the backlight circuit according to the some embodiments of the present disclosure, the first power supply end is connected to the first node, and the second power supply end is connected to the second node.

For example, in the backlight circuit according to the some embodiments of the present disclosure, the current control circuit has a first power supply end, and the first power supply end is connected to the first node.

For example, in the backlight circuit according to the some embodiments of the present disclosure, the current control circuit has a second power supply end, and the second power supply end is connected to the second node.

For example, in the backlight circuit according to the some embodiments of the present disclosure, the power supply circuit comprises: a transformer, a second diode, a second capacitor, a third diode, and a third capacitor; a primary coil of the transformer is configured to receive the power supply voltage, a first secondary coil of the transformer is connected to a positive electrode of the second diode and a common end respectively, a negative electrode of the second diode is connected to a first end of the second capacitor and the first output end, and a second end of the second capacitor is connected to the common end, and a second secondary coil of the transformer is connected to a positive electrode of the third diode and the common end respectively, a negative electrode of the third diode is connected to a first end of the third capacitor and the first node, and a second end of the third capacitor is connected to the common end.

For example, in the backlight circuit according to the some embodiments of the present disclosure, the transformer is a flyback transformer.

For example, in the backlight circuit according to the some embodiments of the present disclosure, a number of turns of the first secondary coil is greater than a number of turns of the second secondary coil.

For example, in the backlight circuit according to the some embodiments of the present disclosure, a number of the at least one second output end is same as a number of the at least one string of light emitting elements, and the at least one second output end is connected to the at least one string of light emitting elements in one-to-one correspondence.

Some embodiments of the present disclosure provide a backlight module comprising a backlight circuit according to any one of the above embodiments.

Some embodiments of the present disclosure provide a display device comprising a backlight module according to any one of the above embodiments.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the invention and thus are not limitative of the invention. Reasonable variations of these drawings are also encompassed within the scope of the present disclosure.

FIG. 1A is a schematic diagram of a connection manner of a backlight circuit according to at least one embodiment of the present disclosure;

FIG. 1B is a schematic diagram of a connection manner of another backlight circuit according to at least one embodiment of the present disclosure;

FIG. 2 is a schematic diagram of a circuit structure of a backlight circuit according to at least one embodiment of the present disclosure;

FIG. 3 is a schematic diagram of a backlight module according to at least one embodiment of the present disclosure;

FIG. 4 is a schematic diagram of a display device according to at least one embodiment of the present disclosure.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

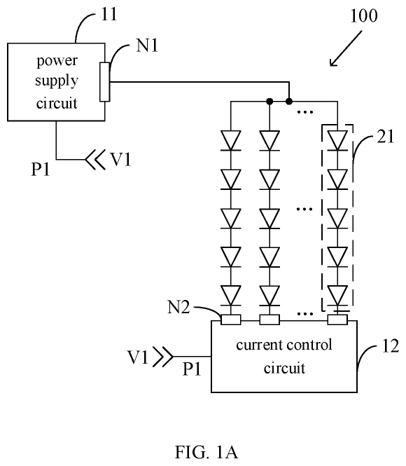

FIG. 1A is a schematic diagram of a connection manner of a backlight circuit according to at least one embodiment of the present disclosure; FIG. 1B is a schematic diagram of a connection manner of another backlight circuit according to at least one embodiment of the present disclosure.

Referring to FIG. 1A, a backlight circuit 100 comprises a first output end N1 and at least one second output end N2. In the backlight module including at least one string of light emitting elements 21, the first output end N1 is connected to a positive power supply end (for example, a positive electrode end of a string formed by light emitting diodes connected in series one by one, in FIG. 1A, taking the string of light emitting elements 21 comprising five light emitting diodes connected in series one by one as a schematic) of the at least one string of light emitting elements 21, the at least one second output end is connected to a negative power supply end (for example, a negative electrode end of the string formed by light emitting diodes connected in series one by one) of each of strings of light emitting elements 21 respectively. As such, the backlight circuit can provide a power supply to each of the strings of light emitting elements 21 through the first output end N1 and the at least one second output end N2 to control a light emitting state of the at least one string of light emitting elements 21.

For example, referring to FIG. 1B, in some examples, the backlight module comprises a plurality of strings of light emitting elements 21, and each of the strings of light emitting elements 21 may comprise a plurality of light emitting elements, such as light emitting diodes. The structures of the plurality of strings of light emitting elements 21 are the same. For example, as shown in FIG. 1B, the backlight module may comprise a first string of light emitting elements 211, a second string of light emitting elements 212, and a third string of light emitting elements 213. The number of light emitting diodes in the first string of light emitting elements 211, the number of light emitting diodes in the second string of light emitting elements 212 and the number of light emitting diodes in the third string of light emitting elements 213 are the same, for example, all are 5. However, the present disclosure is not limited thereto, and the number of light emitting diodes in each of the strings of light emitting elements 21 may be determined according to actual needs. For example, the number of light emitting diodes in the first string of light emitting elements 211, and the number of light emitting diodes in the second string of light emitting elements 212 and the number of light emitting diodes in the third string of light emitting elements 213 may also be 4, 6, 9, and the like.

For example, the positive power supply ends of respective strings of light emitting elements 21 are all directly electrically connected.

“Light emitting diodes connected in series one by one” may indicate that a positive electrode of one light emitting diode is connected to a negative electrode of another light emitting diode. For example, the third string of light emitting elements 213 comprises a first light emitting diode al, a second light emitting diode a2, a third light emitting diode a3, a fourth light emitting diode a4, and a fifth light emitting diode a5. And a positive electrode of the first light emitting diode a1 is used as a positive power supply end of the third string of light emitting elements 213, a negative electrode of the first light emitting diode al is connected to a positive electrode of the second light emitting diode a2, a negative electrode of the second light emitting diode a2 is connected to a positive electrode of the third light emitting diode a3, a negative electrode of the third light emitting diode a3 is connected to a positive electrode of the fourth light emitting diode a4, a negative electrode of the fourth light emitting diode a4 is connected to a positive electrode of the fifth light emitting diode a5, and a negative electrode of the fifth light emitting diode a5 is used as a negative power supply end of the third string of light emitting elements 213.

It should be noted that the numbers of light emitting diodes in the plurality of strings of light emitting elements 21 may also be different, which is not limited in the present disclosure.

For example, a number of the at least one second output end N2 is the same as a number of the at least one string of light emitting elements 21, and the at least one second output end N2 and the at least one string of light emitting elements 21 are connected in one-to-one correspondence. Referring to FIGS. 1A and 1B, in some examples, the backlight module comprises three strings of light emitting elements 21, then the backlight circuit 100 comprises three second output ends N2, and the three strings of light emitting elements 21 are in one-to-one correspondence with the three second output ends N2. Each of the strings of light emitting elements 21 is only connected to one second output end N2.

Referring to FIG. 1A and FIG. 1B, the backlight circuit 100 further comprises a power supply circuit 11, and the power supply circuit 11 is connected to the first output end N1 and a first node P1 respectively. And the power supply circuit 11 is configured to provide a positive power supply voltage for the at least one string of light emitting elements 21 to the first output end N1 and to provide a constant voltage V1 to the first node P1 based on a first buck conversion (a conversion form of the first buck conversion can be, for example, a forward conversion or a flyback conversion) performed on a power supply voltage of the backlight circuit. That is, the power supply circuit 11 is configured to generate the positive power supply voltage and the constant voltage V1 based on the first buck conversion performed on the power supply voltage of the backlight circuit, and the positive power supply voltage is output to the first output end N1 and the constant voltage V1 is output to the first node P1.

For example, the positive power supply voltage is greater than the constant voltage V1.

For example, in one example, the power supply circuit 11 may implement the first buck conversion by using at least one of a DC-DC converter, an AC-DC converter, a chopper circuit, a transformer, etc., and the provided positive power supply voltage can be, for example, a constant direct current voltage having an amplitude of 100 to 180V. It should be understood that the power supply voltage of the backlight circuit may be, for example, from a commercial power of 220V, or may be, for example, a voltage provided to the backlight circuit after the commercial power of 220V being rectified and filtered, and the present disclosure may not be limited thereto.

Referring to FIG. 1A and FIG. 1B, the backlight circuit 100 further comprises a current control circuit 12, and the current control circuit 12 is connected to the first node P1, a second node (not shown in FIGS. 1A and 1B), and each of the at least one second output end N2 (that is, each of the second output ends N2) respectively and is configured to provide a negative power supply voltage, which is obtained by performing a second buck conversion on the constant voltage V1, to the internal second node (not shown in FIGS. 1A and 1B) to control a current between each of the second output ends N2 and the second node. That is, the current control circuit 12 is configured to perform the second buck conversion on the constant voltage V1 to obtain the negative power supply voltage, and then output the negative power supply voltage to the second node.

For example, in one example, the impedance between each of the second output ends N2 and the second node is designed in the current control circuit 12 in accordance with the desired current proportional relationship among the strings of light emitting elements 21 (for example, the currents passing through the respective strings of light emitting elements 21 are equal or gradually increase in a direction away from the power supply). Thus, in a case where the voltage at the positive power supply end of each of the strings of light emitting elements 21 is a constant voltage value (ie, a positive power supply voltage) provided by the power supply circuit 11, the magnitude of the negative power supply voltage of the negative power supply end of each of the strings of light emitting elements 21 determines the magnitude of the current passing through each of the strings of light emitting elements 21, and the current proportional relationship among the respective strings of light emitting elements 21 is fixed by the above design. For example, the current proportional relationship among the respective strings of light emitting elements 21 can be preset by the user according to actual needs. Thereby, the current control circuit 12 can control the current passing through each of the strings of light emitting elements 21 by controlling a step-down amplitude of the negative power supply voltage V2 obtained by performing the second buck conversion on the constant voltage V1. It should be understood that the constant voltage V1 may be, for example, a constant direct current voltage having an amplitude of 9 to 18 V, and the current control circuit 12 may implement the second buck conversion by, for example, a DC-DC conversion circuit, a BUCK circuit, or a BUCK-BOOST circuit, etc.

It can be seen that the above-mentioned backlight circuit 100 can obtain the positive power supply voltage supplied to the string of light emitting elements 21 by performing the first buck conversion on the power supply voltage, and make the current control circuit 12 for controlling the magnitude of the current operate between the constant voltage V1 with a lower voltage and the negative power supply voltage of the string of light emitting elements 21. Thus, it is unnecessary to use high voltage resistant devices in the current control circuit 12 with a relatively complicated structure, thereby achieving the purpose of cost saving. And it is also unnecessary to provide a protection circuit for preventing high voltage damage, thereby contributing to simplifying the circuit structure of the backlight circuit 100.

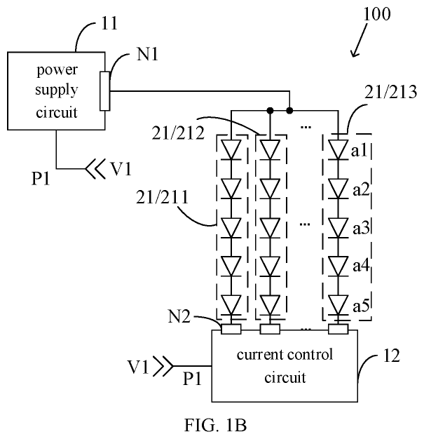

FIG. 2 is a schematic diagram of a circuit structure of a backlight circuit according to at least one embodiment of the present disclosure. Referring to FIG. 2, the backlight circuit 100 may comprise one first output end N1 and at least one second output end N2. For example, in an example shown in FIG. 2, the backlight circuit 100 comprises four second output ends N2. In the backlight module including at least one string of light emitting elements 21, the first output end N1 is connected to a positive power supply end (for example, a positive electrode end of a string formed by light emitting diodes connected in series one by one, in FIG. 2, taking four strings of light emitting elements 21 as an example) of the at least one string of light emitting elements 21, the second output end N2 is connected to a negative power supply end (for example, a negative electrode end of the string formed by light emitting diodes connected in series one by one) of a corresponding string of light emitting elements 21. As such, the backlight circuit can provide a power supply to each of the strings of light emitting elements 21 through the first output end N1 and the at least one second output end N2 to control a light emitting state of the at least one string of light emitting elements 21.

Referring to FIG. 2, the backlight circuit 100 may comprise a power supply circuit 11, a current mirror sub-circuit 121, and a current regulation sub-circuit 122 (compared to the circuit structures described in FIGS. 1A and 1B, the current mirror sub-circuit 121 and the current regulation sub-circuit 122 are both in the current control circuit 12, that is, the current control circuit 12 comprises the current mirror sub-circuit 121 and the current regulation sub-circuit 122).

For example, the current mirror sub-circuit 121 is connected to a second node P2 and each of the second output ends N2 respectively, and the current mirror sub-circuit 121 is configured to lock the current between each of the second output ends N2 and the second node P2 to the same current value and collect the same current value. That is, the currents outputted by the respective second output ends N2 are the same. The current regulation sub-circuit 122 is connected to the current mirror sub-circuit 121, the first node P1, and the second node P2 respectively, and the current regulation sub-circuit 122 is configured to perform the second buck conversion on the constant voltage V1 according to the same current value collected by the current mirror sub-circuit 121, and to provide the negative power supply voltage V2 obtained through the second buck conversion to the second node. It can be seen that, as an implementation example of the current control circuit 12, in the embodiment, the currents passing through respective strings of light emitting elements 21 are locked to the same current value by using a current mirror, and the same current value is used as a feedback amount to adjust the negative power supply voltage V2, so that the control of the magnitude of the current passing through each of the strings of light emitting elements 21 is achieved.

As an example, the current mirror sub-circuit 121 shown in FIG. 2 comprises a first transistor T1, a second transistor T2, a first resistor R1, a second resistor R2, at least one third transistor T3, and at least one third resistor R3 (corresponding to the four strings of light emitting elements 21 shown in FIG. 2, in FIG. 2, taking the current mirror sub-circuit 121 comprising four third transistors T3 and four third resistors R3 as a schematic), and the current regulation sub-circuit 122 comprises an operational amplifier OP.

For example, the number of the at least one third transistor T3 is the same as the number of the at least one third resistor R3, and the at least one third transistor T3 and the at least one third resistor R3 are connected in one-to-one correspondence. The number of the at least one second output end N2 is the same as the number of the at least one third transistor T3, and the at least one second output end N2 and the at least one third transistor T3 are connected in one-to-one correspondence. In the FIG. 2, the backlight circuit 100 comprises four second output ends N2, and the current mirror sub-circuit 121 comprises four third transistors T3 and four third resistors R3.

For example, a first electrode of each third transistor T3 (each of the at least one third transistor T3) is connected to a corresponding second output end N2, a second electrode of each third transistors T3 is connected to a first end of a corresponding third resistor R3. That is, each of the second output ends N2 is connected to the second node P2 sequentially passing through a drain electrode and a source electrode of a third transistor T3 and two ends of a third resistor R3, and a gate electrode of each third transistor T3 is connected to a gate electrode of the second transistor T2. A second end of each third resistor R3 is connected to the second node P2. A gate electrode of the first transistor T1 is connected to an output end of the operational amplifier OP, a first electrode of the first transistor T1 is connected to a first power supply end of the current control circuit 12, a second electrode of the first transistor T1 is connected to a first end of the first resistor R1, the first electrode of the first transistor T1 may be a source electrode, and the second electrode of the first transistor T1 may be a drain electrode; alternatively, the first electrode of the first transistor T1 may be a drain electrode, the second electrode of the first transistor T1 may be a source electrode. The first power supply end may be a positive power supply end Vcc, then one of the source electrode and the drain electrode of the first transistor T1 is connected to the positive power supply end Vcc of the current control circuit 12, the other of the source electrode and the drain electrode of the first transistor T1 is connected to the first end of the first resistor R1 (an upper end in FIG. 2), and a second end of the first resistor R1 is connected to a gate electrode of the second transistor T2. A first electrode of the second transistor T2 is connected to the second end of the first resistor R1, a second electrode of the second transistor T2 is connected to an inverting input end of the operational amplifier OP and a first end of the second resistor R2, the first electrode of the second transistor T2 may be a source electrode, and the second electrode of the second transistor T2 may be a drain electrode; alternatively, the first electrode of the second transistor T2 may be a drain electrode, and the second electrode of the second transistor T2 may be a source electrode, that is, one of the source electrode and the drain electrode of the second transistor T2 is connected to the second end of the first resistor R1, and the other of the source electrode and the drain electrode of the second transistor T2 is connected to the inverting input end of the operational amplifier OP and the first end of the second resistor R2, a second end of the second resistor R2 is connected to the second node P2, and a non-inverting input end of the operational amplifier OP is configured to receive a reference voltage Vref. It should be noted that, according to various specific types of transistors, a connection relationship of a source electrode and a drain electrode of a transistor may be set to match a direction of a current flowing through the transistor. When a transistor has a structure in which a source electrode and a drain electrode are symmetrical, the source electrode and the drain electrode can be regarded as two electrodes which are not particularly distinguished. Therefore, in the present disclosure, one of two electrodes of a transistor is directly described as a first electrode, and the other of the two electrodes of the transistor is directly described as a second electrode.

For example, a type of the second transistor T2 may be the same as a type of the at least one third transistor T3. For example, in some embodiments, the first transistor T1, the second transistor T2, and the at least one third transistor T3 are all N-type transistors, for example, N-type MOS transistors.

For example, a type of the first transistor T1 may be the same as the type of the second transistor T2 and the type of the at least one third transistor T3. For example, the first transistor T1 may also be an N-type transistor.

For example, referring to FIG. 2, the first power supply end is electrically connected to the first node P1. However, the present disclosure is not limited thereto, and the first power supply end may also be a separate power supply end provided by a circuit system.

It can be seen that the second transistor T2, the second resistor R2, all of the third transistors T3 and all of the third resistors R3 constitute a current mirror structure. The second transistor T2 and each of the third transistors T3 can have identical device parameters, each of the third resistors R3 may have an identical resistance value, thus, the second transistor T2 and the third transistor T3 whose gate electrodes are connected together may have the same operating state, so that each of the third transistors T3 and the second transistor T2 has an identical drain-source current, thereby achieving the above-described function of locking the current between each of the second output ends N2 and the second node P2 to the same current value.

It can also be seen that the positive power supply end Vcc shared by the current mirror sub-circuit 121 and the current regulation sub-circuit 122 can provide voltages having the same magnitude (in the example shown in FIG. 2, that is, the constant voltage V1 provided by the first node P1 described above) to the operational amplifier OP and the drain electrode of the first transistor T1, respectively, and the negative power supply end (in the example shown in FIG. 2, that is, the second node P2) shared by the current mirror sub-circuit 121 and the current regulation sub-circuit 122 can provide voltages having the same magnitude to the operational amplifier OP and the second end of the second resistor R2, respectively.

On the basis of this, based on the voltage V2 at the second node P2, the second resistor R2 can be used to collect the current value passing through each of the strings of light emitting elements 21 based on a relationship that the current values of respective strings of light emitting elements 21 are equal(a voltage value of the inverting input end of the operational amplifier OP is equal to a product of this current value and a resistance value of the second resistor R2). Because the operational amplifier OP can output an output voltage having a voltage value, which is equal to a product of a voltage difference between the non-inverting input end and the inverting input end and an amplification factor of the operational amplifier OP, at the output end of the operational amplifier, and moreover, the output voltage is also outputted to the gate electrode of the first transistor T1, so that the magnitude of the current value passing through each of the strings of light emitting elements 21 can be controlled according to the device characteristics of the first transistor T1, thereby forming a negative feedback adjustment for the current value. The magnitude of the current value in a balanced state is determined by the resistance value of the first resistor R1, the resistance value of the second resistor R2, the device parameters of the first transistor T1, the device parameters of the second transistor T2, the device parameters of the operational amplifier OP, and the magnitude of the reference voltage Vref and the magnitude of the voltage V2 at the second node P2 together. In one example, in a case where the circuit structure is fixed, this current value can be changed by adjusting the magnitude of the reference voltage Vref and/or the magnitude of the voltage V2 at the second node P2. In still another example, the magnitude of the current passing through each of the strings of light emitting elements 21 can be set by setting the resistance value of the second resistor R2 without changing other conditions.

As an example, the current regulation sub-circuit 121 in FIG. 2 also comprises a fourth transistor T4, an inductor L1, a first diode D1, a first capacitor C1, and a pulse width modulation circuit 1221. For example, a gate electrode of the fourth transistor T4 is connected to a pulse signal output end (an upper end in FIG. 2) of the pulse width modulation circuit 1221, a first electrode of the fourth transistor T4 is connected to the first node P1, and a second electrode of the fourth transistor T4 is connected to a first end of the inductor L1 and a negative electrode of the first diode D1. That is, one of a source electrode and a drain electrode of the fourth transistor T4 is connected to the first node P1, and the other of the source electrode and the drain electrode of the fourth transistor T4 is connected to the first end (the upper end in FIG. 2) of the inductor L1 and the negative electrode of the first diode D1. A second end of the inductor L1 is connected to a common end, a positive electrode of the first diode D1 is connected to the second node P2 and a first end (the upper end in FIG. 2) of the first capacitor C1, a second end of the first capacitor C1 is connected to the common end. An input end of the pulse width modulation circuit 1221 is connected to an output end of the operational amplifier OP, the pulse width modulation circuit 1221 is further connected to the first power supply end (that is, the positive power supply end Vcc) and a second power supply end (that is, the negative power supply end) of the current control circuit 12 respectively, and the pulse width modulation circuit 1221 is configured to modulate a duty ratio of a pulse signal at the pulse signal output end of the pulse width modulation circuit 1221 according to a signal received at the input end of the pulse width modulation circuit 1221 to control a current between the first output end N1 and the second node P2, for example, to keep the current between the first output end N1 and the second node P2 constant.

For example, the second power supply end is connected to the second node P2.

For example, the common end can be grounded.

It can be seen that the fourth transistor T4, the inductor L1, the first diode D1, the first capacitor C1 and the pulse width modulation circuit 1221 can form a BUCK-BOOST architecture. When the fourth transistor T4 is in an on state, the constant voltage V1 at the first node P1 charges the inductor L1 through the source electrode and the drain electrode of the fourth transistor T4. And when the fourth transistor T4 is in an off state, the inductor L1 continues to freewheel through the first diode D1 and the first capacitor C1. At this time, the first diode D1 is in an on state and the first capacitor C1 is charged. For example, when the duty ratio of the pulse signal is d, in the continuous current operation mode, the voltage across the first capacitor C1 is −d*V1/(1−d), and the voltage across the first capacitor C1 is the negative power supply voltage V2, that is, V2=−d*V1/(1−d). The current direction is from the second node P2 to the common end (this current is a current between the first output end N1 and the second node P2, that is, a total current of all of the strings of light emitting elements 21). Thus, the process of performing the second buck conversion on the constant voltage V1 to obtain the negative power supply voltage V2 is implemented. The present disclosure is not limited to the above examples, and the duty ratio of the pulse signal can be controlled based on different needs for different application scenarios.

It can be seen that, in the above example, the current control circuit 12 can have a first power supply end (ie, a positive power supply end VCC) and a second power supply end (ie, a negative power supply end), the positive power supply end Vcc is connected to the first node P1 and the negative power supply end is connected to the second node P2. That is, the circuit in the embodiment of the present disclosure can achieve power supply and light-emitting control of at least one string of light emitting elements 21 under the power supply of two voltages (the positive power supply voltage and the constant voltage V1) provided by the power supply circuit 11, thereby contributing to further simplifying the circuit structure of the backlight circuit.

As an example, the power supply circuit 11 in FIG. 2 comprises a transformer TR, a second diode D2, a second capacitor C2, a third diode D3, and a third capacitor C3. For example, the transformer TR may be a flyback transformer, a primary coil of the flyback transformer TR is configured to receive the power supply voltage Vbus, that is, the primary coil (for example, a primary side) of the flyback transformer TR is connected to the power supply voltage Vbus (a voltage provided to the backlight circuit after a commercial power of 220V being rectified and filtered) and a AC-DC flyback controller 111 of the flyback transformer TR. A first secondary coil (for example, a first secondary side (a secondary side on the upper end in FIG. 2)) of the flyback transformer TR is connected to a positive electrode of the second diode D2 and a common end respectively, a negative electrode of the second diode D2 is connected to a first end (the upper end in FIG. 2) of the second capacitor C2 and the first output end N1, and a second end of the second capacitor C2 is connected to the common end. A second secondary coil (for example, a second secondary side (a secondary side on the lower end in FIG. 2)) of the flyback transformer TR is connected to a positive electrode of the third diode D3 and the common end respectively, a negative electrode of the third diode D3 is connected to a first end (the upper end in FIG. 2) of the third capacitor C3 and the first node P1, and a second end of the third capacitor C3 is connected to the common end.

For example, the number of turns of the first secondary coil is greater than the number of turns of the second secondary coil.

It can be seen that the second diode D2 and the second capacitor C2 can rectify and filter the voltage outputted by the first secondary coil (for example, the first secondary side) to obtain the above-mentioned positive power supply voltage at the first output end N1. The third diodes D3 and the third capacitor C3 can rectify and filter the voltage outputted by the second secondary coil (for example, the second secondary side) to obtain the above-mentioned constant voltage V1 at the first node P1. And the magnitudes of the two voltages can be determined according to the internal setting of the flyback transformer TR. As an example, the above-mentioned positive power supply voltage may be 160V, and the above-mentioned constant voltage V1 may be 12V

It can be seen that in the circuit structure shown in FIG. 2, all of the devices in the current control circuit 12 operate between the constant voltage V1 and the negative power supply voltage V2 at the second node P2. Thus, these devices will not withstand high voltages having amplitudes beyond this range. Thus, it is unnecessary to use high voltage resistant devices and it is also unnecessary to provide a protection circuit for preventing high voltage damage. Thus, embodiments of the present disclosure can contribute to simplifying the structure of the backlight circuit.

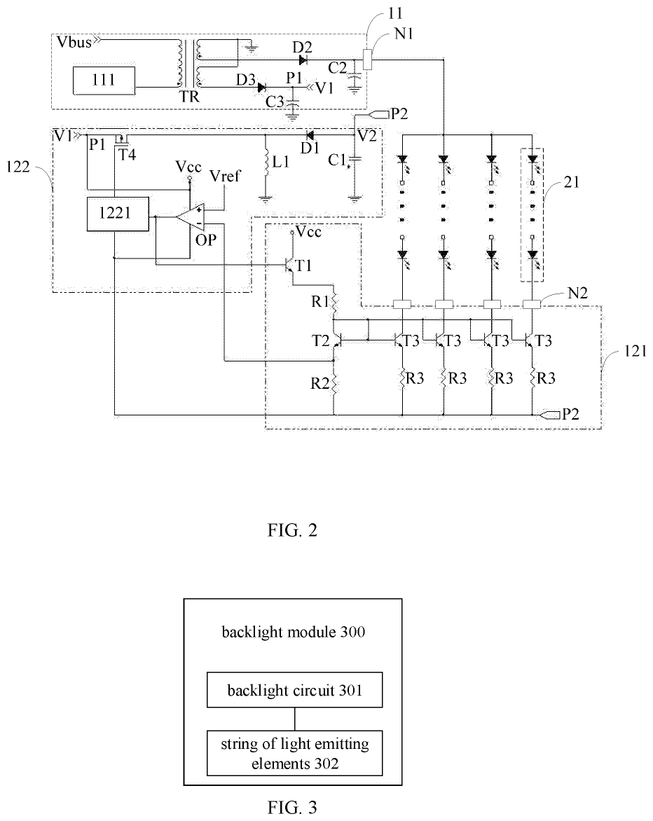

Based on the same inventive concept, some embodiments of the present disclosure further provide a backlight module. FIG. 3 is a schematic diagram of a backlight module according to at least one embodiment of the present disclosure. For example, as shown in FIG. 3, the backlight module 300 can comprise a backlight circuit 301, and the backlight circuit 301 can be any one of the above-mentioned backlight circuits 100. It can be understood that, based on the above-mentioned beneficial effects, the circuit structure of the backlight module 300 can be simplified and the manufacturing cost of the backlight module 300 can be reduced.

For example, as shown in FIG. 3, the backlight module 300 further comprises a string of light emitting elements 302. The backlight circuit 301 is configured to provide a positive power supply voltage and a negative power supply voltage for the string of light emitting elements 302 to control the string of light emitting elements 302 to emit light. For example, the string of light emitting elements 302 may be the at least one string of light emitting elements 21 as described in any one of the above embodiments.

For example, the backlight module 300 may further comprise a reflective sheet, an optical film (for example, a brightness enhancement film, etc.), a diffusion plate (not shown in FIG. 3), and the like.

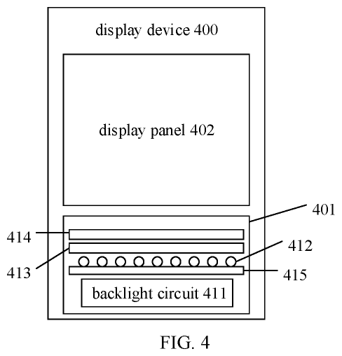

Based on the same inventive concept, some embodiments of the present disclosure further provide a display device. FIG. 4 is a schematic diagram of a display device according to at least one embodiment of the present disclosure. For example, as shown in FIG. 4, the display device 400 may comprise a backlight circuit 411, and the backlight circuit 411 can be the backlight circuits 300 provided in any one of the above embodiments.

For example, the display device 400 may comprise a backlight module 401 and a display panel 402. The backlight module 401 comprises the above-mentioned backlight circuit 411 and the string of light emitting elements 412. The string of light emitting elements 412 may be the at least one string of light emitting elements 21 as described in any one of the above embodiments. The backlight module 401 is configured to provide a light source for the display panel 402.

For example, the backlight module 401 may be a direct type backlight. The backlight module 401 may further comprise a diffusion plate 413, an optical film 414, a reflection sheet 415, and the like.

For example, the display panel 402 may be a liquid crystal display panel, an electronic paper display panel, or the like.

For example, the display panel 402 may be a rectangular panel, a circular panel, an elliptical panel or a polygonal panel, or the like. For example, the display panel 402 may also be provided with a touch function, that is, the display panel 402 may be a touch display panel.

For example, the display device 400 in the embodiment of the present disclosure may be any product or component having a display function, such as a mobile phone, a tablet computer, a television, a display, a notebook computer, a digital photo frame, a navigator, and the like.

It can be understood that, based on the above-mentioned beneficial effects, the circuit structure of the backlight module 401 in the display device 400 can be simplified and the manufacturing cost of the display device 400 can be reduced.

It should be noted that other components of the display device (for example, a control apparatus, an image data encoding/decoding apparatus, a clock circuit, etc.) should be understood by those of ordinary skill in the art, will not be described herein and should not be construed as a limitation of the present disclosure.

The following statements should be noted:

(1) The accompanying drawings involve only the structure(s) in connection with the embodiment(s) of the present disclosure, and other structure(s) can be referred to common design(s).

(2) For the purpose of clarity only, in accompanying drawings for illustrating the embodiment(s) of the present disclosure, the thickness and size of a layer or a structure may be enlarged. However, it should be understood that, in the case in which a component or an element such as a layer, a film, an area, a substrate or the like is referred to be “on” or “under” another component or element, the component or then element may be directly on or under the another component or element, or an intermediate component or element may be interposed therebetween.

(3) In case of no conflict, features in one embodiment or in different embodiments can be combined.

What are described above is related to the preferred embodiment of the present disclosure only and not limitative to the scope of the disclosure. Any modifications, equivalent substitutions, improvements, etc., which are within the spirit and principles of the present disclosure, shall all fall within the scope of protection of the present disclosure.

What is claimed is:

1. A backlight circuit, comprising:
a first output end configured to connect to a positive power supply end of at least one string of light emitting elements;
at least one second output end configured to connect to a negative power supply end of the at least one string of light emitting elements respectively;
a power supply circuit connected to the first output end and a first node respectively, and configured, based on a first buck conversion performed on a power supply voltage, to provide a positive power supply voltage for the at least one string of light emitting elements to the first output end and to provide a constant voltage to the first node; and
a current control circuit connected to the first node, a second node, and each of the at least one second output end respectively and configured to provide a negative power supply voltage, which is obtained by performing a second buck conversion on the constant voltage, to the second node to control a current between each of the at least one of second output end and the second node.

2. The backlight circuit according to claim 1, wherein the current control circuit comprises a current mirror sub-circuit,
the current mirror sub-circuit is connected to the second node and each of the at least one second output end respectively, and
the current mirror sub-circuit is configured to lock the current between the second node and each of the at least one of second output end to a same current value and collect the same current value.

3. The backlight circuit according to claim 2, wherein the current control circuit further comprises a current regulation sub-circuit,
the current regulation sub-circuit is connected to the current minor sub-circuit, the first node, and the second node respectively, and
the current regulation sub-circuit is configured to perform the second buck conversion on the constant voltage according to the same current value collected by the current mirror sub-circuit, and to provide the negative power supply voltage obtained through the second buck conversion to the second node.

4. The backlight circuit according to claim 3, wherein the current mirror sub-circuit comprises a first transistor, a second transistor, a first resistor, a second resistor, at least one third transistor, and at least one third resistor, and the current regulation sub-circuit comprises an operational amplifier;
a first electrode of each of the at least one third transistor is connected to a corresponding second output end of the at least one second output end, a second electrode of each of the at least one third transistor is connected to a first end of a corresponding third resistor of the at least one third resistor, and a gate electrode of each of the at least one third transistor is connected to a gate electrode of the second transistor,
a second end of each of the at least one third resistor is connected to the second node,
a gate electrode of the first transistor is connected to an output end of the operational amplifier, a first electrode of the first transistor is connected to a first power supply end of the current control circuit, a second electrode of the first transistor is connected to a first end of the first resistor, and a second end of the first resistor is connected to a gate electrode of the second transistor, and
a first electrode of the second transistor is connected to the second end of the first resistor, a second electrode of the second transistor is connected to an inverting input end of the operational amplifier and a first end of the second resistor, a second end of the second resistor is connected to the second node, and a non-inverting input end of the operational amplifier is configured to receive a reference voltage.

5. The backlight circuit according to claim 4, wherein a type of the second transistor is same as a type of the at least one third transistor.

6. The backlight circuit according to claim 4, wherein the first power supply end is electrically connected to the first node.

7. The backlight circuit according to claim 4, wherein a number of the at least one third transistor is same as a number of the at least one third resistor, and the at least one third transistor and the at least one third resistor are connected in one-to-one correspondence.

8. The backlight circuit according to claim 4, wherein a number of the at least one second output end is same as a number of the at least one third transistor, and the at least one second output end and the at least one third transistor are connected in one-to-one correspondence.

9. The backlight circuit according to claim 4, wherein the current regulation sub-circuit further comprises a fourth transistor, an inductor, a first diode, a first capacitor, and a pulse width modulation circuit;
a gate electrode of the fourth transistor is connected to a pulse signal output end of the pulse width modulation circuit, a first electrode of the fourth transistor is connected to the first node, and a second electrode of the fourth transistor is connected to a first end of the inductor and a negative electrode of the first diode,
a second end of the inductor is connected to a common end,
a positive electrode of the first diode is connected to the second node and a first end of the first capacitor,
a second end of the first capacitor is connected to the common end, and
an input end of the pulse width modulation circuit is connected to an output end of the operational amplifier, the pulse width modulation circuit is further connected to the first power supply end and a second power supply end of the current control circuit respectively, and
the pulse width modulation circuit is configured to modulate a duty ratio of a pulse signal at the pulse signal output end according to a signal received at the input end of the pulse width modulation circuit, to keep a current between the first output end and the second node constant.

10. The backlight circuit according to claim 9, wherein the first power supply end is connected to the first node, and the second power supply end is connected to the second node.

11. The backlight circuit according to claim 1, wherein the current control circuit has a first power supply end, and the first power supply end is connected to the first node.

12. The backlight circuit according to claim 1, wherein the current control circuit has a second power supply end, and the second power supply end is connected to the second node.

13. The backlight circuit according to claim 1, wherein the power supply circuit comprises: a transformer, a second diode, a second capacitor, a third diode, and a third capacitor;
a primary coil of the transformer is configured to receive the power supply voltage,
a first secondary coil of the transformer is connected to a positive electrode of the second diode and a common end respectively, a negative electrode of the second diode is connected to a first end of the second capacitor and the first output end, and a second end of the second capacitor is connected to the common end, and
a second secondary coil of the transformer is connected to a positive electrode of the third diode and the common end respectively, a negative electrode of the third diode is connected to a first end of the third capacitor and the first node, and a second end of the third capacitor is connected to the common end.

14. The backlight circuit according to claim 13, wherein the transformer is a flyback transformer.

15. The backlight circuit according to claim 13, wherein a number of turns of the first secondary coil is greater than a number of turns of the second secondary coil.

16. The backlight circuit according to claim 2, wherein the power supply circuit comprises: a transformer, a second diode, a second capacitor, a third diode, and a third capacitor;
a primary coil of the transformer is configured to receive the power supply voltage,
a first secondary coil of the transformer is connected to a positive electrode of the second diode and a common end respectively, a negative electrode of the second diode is connected to a first end of the second capacitor and the first output end, and a second end of the second capacitor is connected to the common end, and
a second secondary coil of the transformer is connected to a positive electrode of the third diode and the common end respectively, a negative electrode of the third diode is connected to a first end of the third capacitor and the first node, and the second end of the third capacitor is connected to the common end.

17. The backlight circuit according to claim 3, wherein the power supply circuit comprises: a transformer, a second diode, a second capacitor, a third diode, and a third capacitor;
a primary coil of the transformer is configured to receive the power supply voltage,
a first secondary coil of the transformer is connected to a positive electrode of the second diode and a common end respectively, a negative electrode of the second diode is connected to a first end of the second capacitor and the first output end, and a second end of the second capacitor is connected to the common end, and
a second secondary coil of the transformer is connected to a positive electrode of the third diode and the common end respectively, a negative electrode of the third diode is connected to a first end of the third capacitor and the first node, and the second end of the third capacitor is connected to the common end.

18. The backlight circuit according to claim 1, wherein a number of the at least one second output end is same as a number of the at least one string of light emitting elements, and
the at least one second output end is connected to the at least one string of light emitting elements in one-to-one correspondence.

19. A backlight module comprising a backlight circuit,
wherein the backlight circuit comprises:
a first output end configured to connect to a positive power supply end of at least one string of light emitting elements;
at least one second output end configured to connect to a negative power supply end of the at least one string of light emitting elements respectively;
a power supply circuit connected to the first output end and a first node respectively, and configured, based on a first buck conversion performed on a power supply voltage, to provide a positive power supply voltage for the at least one string of light emitting elements to the first output end and to provide a constant voltage to the first node; and
a current control circuit connected to the first node, a second node, and each of the at least one second output end respectively and configured to provide a negative power supply voltage, which is obtained by performing a second buck conversion on the constant voltage, to the second node to control a current between each of the at least one of second output end and the second node.

20. A display device comprising a backlight module,
wherein the backlight module comprises a backlight circuit, and the backlight circuit comprises:
a first output end configured to connect to a positive power supply end of at least one string of light emitting elements;
at least one second output end configured to connect to a negative power supply end of the at least one string of light emitting elements respectively;
a power supply circuit connected to the first output end and a first node respectively, and configured, based on a first buck conversion performed on a power supply voltage, to provide a positive power supply voltage for the at least one string of light emitting elements to the first output end and to provide a constant voltage to the first node; and
a current control circuit connected to the first node, a second node, and each of the at least one second output end respectively and configured to provide a negative power supply voltage, which is obtained by performing a second buck conversion on the constant voltage, to the second node to control a current between each of the at least one of second output end and the second node.
